(19) United States
(12) Patent Application Publication
(10) Pub. No.: US 2007/0266635 A1
(43) Pub. Date: Nov. 22, 2007

(54) Vehicle Door Opening/Closing Control Apparatus

(75) Inventors: Takehiko Sugiura, Kariya-shi (JP); Masayoshi Takeuchi, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/747,384

(22) Filed: May 11, 2007

(30) Foreign Application Priority Data
May 17, 2006 (JP) 2006-137809

(51) Int. Cl. E05F 15/10

(52) U.S. Cl. 49/27; 49/26

(57) ABSTRACT

A vehicle door opening/closing control apparatus includes an actuator for executing a door opening action and a door closing action by applying a driving force to a vehicle door, non-contact type object detecting means for detecting an object at an apertural area, contact type object detecting means for detecting a contact of the object to the vehicle door and control means for: controlling the actuator to execute the door closing action for the vehicle door with changing a speed of the door closing action for the vehicle, on the basis of a detection result from the non-contact type object detecting means, during the door closing action; and controlling the actuator to stop the door closing action after a stop operation or a reverse operation for the actuator is executed, on the basis of a detection result from the contact type object detecting means, during the door closing action.

### CROSS REFERENCE TO RELATED APPLICATIONS

This application is based on and claims priority under 35 U.S.C. § 119 to Japanese Patent Application 2006-137809 filed on May 17, 2006, the entire content of which is incorporated herein by reference.

### FIELD OF THE INVENTION

The present invention relates to a vehicle door opening/closing control apparatus having an actuator supplying a driving force to a vehicle door so that the vehicle door is moved and control means for controlling the actuator.

### BACKGROUND

A slide door provided at a vehicle of an automobile or a railroad includes an electric power moving apparatus for opening and closing an apertural area formed at a vehicle body of the vehicle by sliding the side door by use of a driving force generated at an actuator such as a motor (hereinafter referred to as an electric power movement). At such electric power moving apparatus, during a door closing action, an object may be entrapped between a jamb and the door. Thus, an electric power moving apparatus having a control means for controlling an operation of the actuator so as to stop a door closing action or so as to stop the door after a door opening action (hereinafter referred to as a reverse operation), by detecting the entrapment of the object between the jamb and the door, has been needed.

For example, a patent document JP3300660B discloses an automatic moving apparatus for surely detecting an entrapment of an object at a moving body such as a door panel of the slide door of a vehicle. Specifically, the automatic moving apparatus disclosed in JP3300660B includes a pressure-sensitive sensor for detecting a pressure generated upon the entrapment of the object. The pressure-sensitive sensor is comprised of an outer portion and plural conductive wires. The outer portion is made of an elastic material and formed so as to be in a long-tube shape having a hollow therein. Because the hollow has a cross-shaped section, it will be referred to as a cross-shaped hole in this section. Specifically, the cross-shaped section of the hollow has a diameter varying relative to a center point of the long-tube shaped outer portion and the plural conductive wires are provided along the cross-shaped hole so as to spirally extend in a longitudinal direction thereof with being distanced each other. When the object is entrapped, because a pressure is applied to the pressure-sensitive sensor, the outer portion is elastically deformed so that the cross-shaped hole also changes its shape. Accordingly, selected conductive wires provided along the cross-shaped hole contact each other so as to be conducted each other, and at this point, the entrapment of the object is detected on the basis of the conduct between the conductive wires.

Such pressure-sensitive sensor is effective in terms of being able to detect the entrapment of the object at the automatic moving apparatus with a simple configuration. However, because an external force applied by the object to the sensor at an early stage of the entrapment is too weak to deform the cross-shaped hole within the outer portion of the sensor, the pressure-sensitive sensor may not detect the object appropriately at the early stage of the entrapment. Further, a movable body such as the door panel moves at a normal speed at the early stage of the entrapment, or even until the pressure-sensitive sensor detects the entrapment. Thus, even when the entrapment occurs, the movable body further moves until it is stopped or until it moves in an opposite direction after the entrapment is detected. Thus, a level of the force applied to the object is relatively high, and a time period during which the external force caused by the entrapment is applied by the object may be long. The level of the force applied to the object needs to be lowered, and the time period during which the external force caused by the entrapment is applied by the object needs to be reduced. In order to reduce the force applied to the object, a speed of the movable body may be reduced. However, in this situation, the movable body may become less convenient. Further, the speed of the movement of the movable body may be reduced at a predetermined position, for example, at a point immediately before the door closing action. However, when a distance between this predetermined position and a position where the door closing action is executed is short, only a limited effect may be obtained, and when the distance is long, the electric power moving apparatus may become less convenient. Furthermore, a contact of the object to the movable body may not occur at the predetermined position. Instead of the above-mentioned sensor, a non-contact type sensor using such as supersonic or light may be used for detecting an object existing on a locus of the movable body. In this configuration, the sensor determines a possibility of an entrapment before the object actually contacts the movable body in order to control the movement of the movable body. However, depending on a directivity of the non-contact type sensor, the sensor may detect the object existing out of the locus of the movable body. It is not necessary to detect the object existing out of the locus of the movable body. When the movable body is controlled on the basis of this unnecessary detection, the electric power moving apparatus may become less convenient.

A need thus exists to provide a vehicle door opening/closing control apparatus by which an impact applied to the object when it is entrapped by the vehicle door is reduced, and the object is released form the entrapment as soon as possible, while convenience of a vehicle door moved by an electric power is maintained.

### SUMMARY OF THE INVENTION

According to an aspect of the present invention, a vehicle door opening/closing control apparatus includes an actuator for executing a door opening action and a door closing action for a vehicle door in order to open and close an apertural area formed at a vehicle body by applying a driving force to the vehicle door, non-contact type object detecting means for detecting an existence of an object at the apertural area of the vehicle body while the door closing action is executed for the vehicle door, contact type object detecting means for detecting a contact of the object to the vehicle door so that the door closing action for the vehicle door is interrupted and control means for controlling the actuator to execute the door opening action and the door closing action for the vehicle door at a predetermined speed. The control means for controlling the actuator to execute the door closing action for the vehicle door with changing a speed of the door closing action for the vehicle on the basis of a detection result from the non-contact type object detecting means during the actuator is controlled to execute the door closing action for the vehicle door. The control means for controlling the actuator to stop the door closing action after one of a stop operation and a reverse operation for the actuator is executed on the basis of a detection result from the contact type object detecting means during the actuator is controlled to execute the door closing action for the vehicle door.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a block diagram schematically indicating a configuration of a vehicle door opening/closing control apparatus of the present invention;

FIG. 2 illustrates a block diagram schematically indicating an example of an embodiment of the vehicle door opening/closing control apparatus;

FIG. 3 illustrates an explanation diagram indicating a non-contact detection by means of a microwave radar;

FIG. 4 illustrates an oblique perspective view indicating a door operating portion;

FIG. 5 illustrates a flow chart indicating an example of a control executed by the vehicle door opening/closing control apparatus;

FIG. 6 illustrates a block diagram schematically indicating another configuration of the vehicle door opening/closing control apparatus related to the present invention;

FIG. 7 illustrates indicating an example of the control executed by the vehicle door opening/closing control apparatus;

FIG. 8 illustrates an oblique perspective view indicating a configuration of a pressure-sensitive sensor serving as one example of a contact type object detecting means;

FIG. 9 illustrates an oblique perspective view indicating a configuration of a piezoelectric sensor serving as one of the contact type object detecting means;

FIG. 10 illustrates an oblique perspective view indicating an example in which the pressure-sensitive sensor and the piezoelectric sensor are provided at the vehicle door;

FIG. 11 illustrates a block diagram schematically indicating a configuration of the vehicle door opening/closing control apparatus having the piezoelectric sensor; and

FIG. 12 illustrates a block diagram schematically indicating another configuration of the vehicle door opening/closing control apparatus having the piezoelectric sensor.

### DETAILED DESCRIPTION

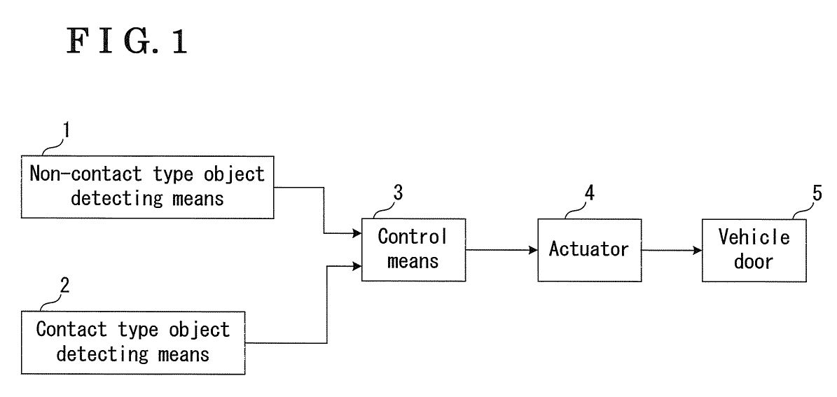

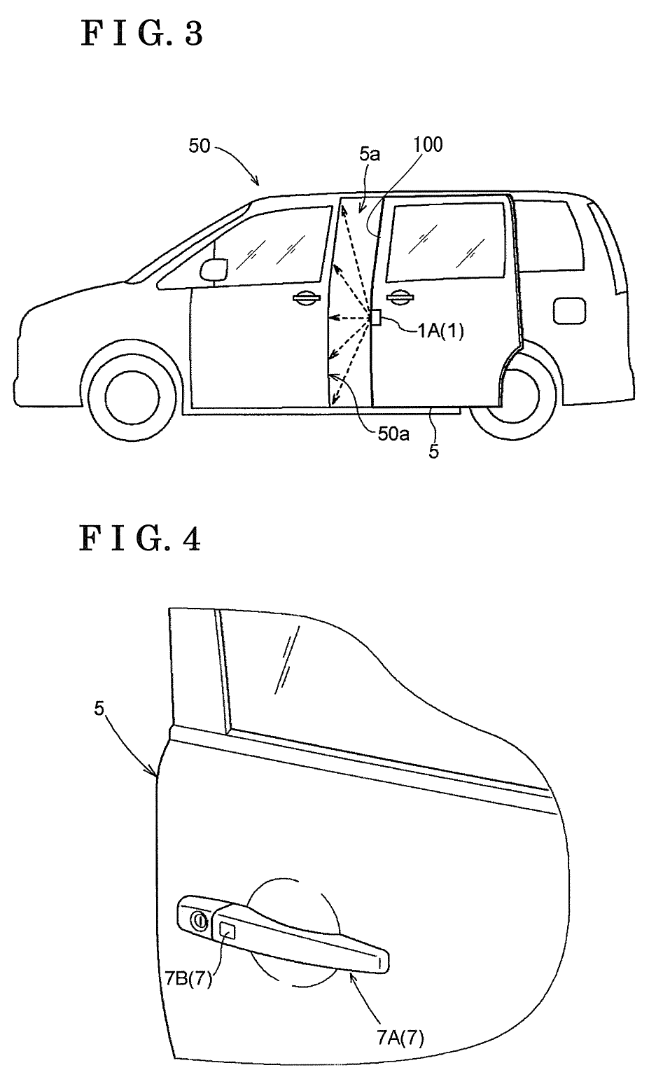

An embodiment of the present invention will be explained in accordance with the attached drawings. As illustrated in FIG. 1 and FIG. 3, a vehicle door opening/closing control apparatus of the present invention includes an actuator 4 for moving a vehicle door 5 by supplying a driving force thereto and a control means 3 for controlling the actuator 4. The vehicle door opening/closing control apparatus further includes a non-contact type object detecting means 1 and a contact type object detecting means 2. The non-contact type object detecting means 1 detects an object existing at an apertural area 5a formed at the vehicle body 50, when the door closing action of the vehicle door is executed, the apertural area 5a being opened/closed by the vehicle door 5. The contact type object detecting means 2 detects a contact to the vehicle door 5 by the object, which may interrupt the door closing action of the vehicle door 5. The control means 3 changes a speed of the door closing action of the vehicle door 5 by means of the actuator 4 on the basis of the detection result from the non-contact type object detecting means 1. Specifically, the control means 3 changes the speed of the door closing action of the vehicle door 5 so as to be lower than a predetermined speed. Further, the control means 3 executes a stop operation or a reverse operation for the actuator 4 on the basis of the detection result from the contact type object detecting means 2. More specifically, the control means 3 executes the stop operation and the reverse operation for the actuator 4 when the contact type object detecting means 2 detects the contact of the object to the vehicle door 5. Further, the control means 3 doesn't execute the stop operation or the reverse operation for the actuator when the contact type object detecting means 2 does not detect the contact of the object to the vehicle door 5, even when the non-contact type object detecting means 1 detects the object existing at the apertural area 5a of the vehicle body 50.

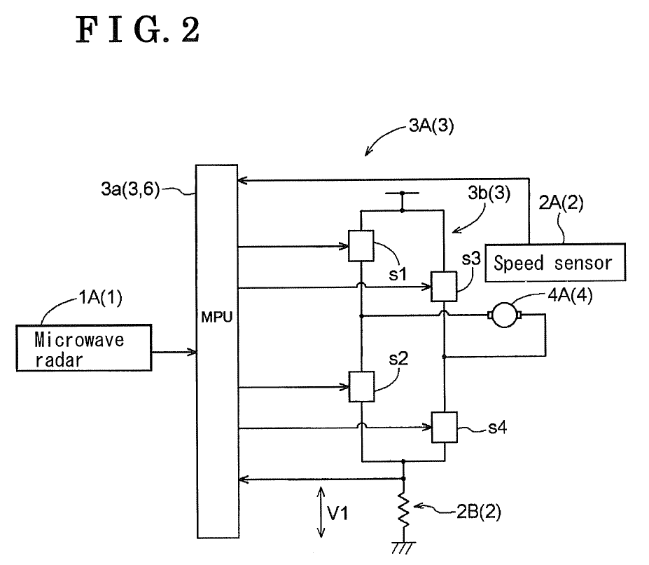

As illustrated in FIG. 2, an ECU (electronic control unit) 3A is provided as an example of the control means 3. In this example, the ECU 3A includes a MPU (micro processing unit) 3a and a bridge circuit 3b. The MPU 3a comprises a core part of the control means 3. On the basis of the detection results from the non-contact type object detecting means 1 and the contact type object detecting means 2, the MPU 3a controls the actuator 4 via the bridge circuit 3b.

A microwave radar 1A serving as the non-contact type object detecting means is comprised as a unit having a sending device and a receiving device integrally and attached to an end portion 100 of the vehicle door 5 as illustrated 3, in order to scan an end portion 50a of the apertural area 5a of the vehicle body 50. The detection result from the microwave radar 1A is inputted to the MPU 3a. The MPU 3a compares a position of the vehicle door 5 and the detection result related to a distance from the microwave radar 1A in order to detect an existence of the object at the apertural area 5a of the vehicle door 5. The position of the vehicle door 5 may be detected by use of a position detecting sensor (not shown) or a speed sensor 2A (corresponding to the position detecting means) for detecting a speed of a motor 4A.

The bridge circuit 3b supplies a driving current to the motor 4A serving as the actuator 4. As illustrated in FIG. 2, the bridge circuit 3b includes switching means s1, s2, s3 and s4. As the switching means s1, s2, s3 and s4, a power transistor, a power MOSFET (metal oxide silicon field effect transistor), IGBT (insulated gate bipolar transistor), IPS/IPD (intelligent power switch/device) are used, and a fly (free) wheel diode is provided so as to be parallel therewith.

Each of the switching means s1 and s3 includes a high side switch, and each of the switching means s2 and s4 includes a low side switch. The switching means s1, s2, s3 and s4 are turned on and off respectively by the MPU 3a so that an amount and a direction of the electric current can be controlled. For example, while the switching means s1 and s4 are turned on, the electric current flows in one direction, and while the switching means s2 and s3 are turned on, the electric current flows in the other direction (opposite direction). Thus, by controlling the direction of the electric current, a direction of the rotation of the motor 4A is controlled. Further, the amount of the electric current can be controlled by turning on the high side switch serving as the switching means s1 (s3) and executing a PWM control for the low side switch serving as the switching means s4 (s2). On the basis of the direction of the electric current, the direction of the rotation of the motor 4A is controlled, as a result, the direction of the movement of the vehicle door 5 can also be controlled. Further, on the basis of the amount of the electric current, a torque and the speed of the motor 4A are controlled, as a result, the speed of the movement of the vehicle door 5 can also be controlled.

A shunt resistance 2B is provided at the bridge circuit 3b in order to measure the electric current value provided to the motor 4A. Actually, the electric current value is measured on the basis of a voltage of the shunt resistance 2B (voltage V1). Once the object contacts the vehicle door 5, the movement of the vehicle door 5 and the rotation of the motor 4A are interrupted. Accordingly, the electric current value measured by the shunt resistance 2B varies, as a result, the MPU 3a detects the contact of the object to the vehicle door 5 on the basis of the electric current detected by the shunt resistance 2B. The shunt resistance 2B corresponds to the contact type object detecting means 2 of the present invention.

Further, in the vicinity of the motor 4A, the speed sensor 2A is provided. A detection result from the speed sensor 2A is inputted to the MPU 3a. As mentioned above, once the object contacts the vehicle door 5, the movement of the vehicle door 5 and the rotation of the motor 4A are interrupted, as a result, the contact of the object to the vehicle door 5 is detected on the basis of the detection result from the speed sensor 2A. The speed sensor 2A corresponds to the contact type object detecting means 2 of the present invention.

As illustrated in FIG. 4, the vehicle door 5 includes a door handle 7A, and when a passenger operates the door handle 7A, the electric power movement of the vehicle door 5 is executed. For example, while the door closing action is executed for the vehicle door 5, when the passenger pulls the door handle 7A, it is determined that the passenger instructs the door opening action, as a result, the door opening action is electrically executed for the vehicle door 5. Further, the door handle 7A includes a switch 7B. For example, while the door opening action is executed for the vehicle door 5, when the switch 7B is turned on, it is determined that the passenger instructs the door closing action, the door closing action is electrically executed for the vehicle door 5. The electric power movement may be executed on the basis of an instruction from the passenger transmitted by use of an operation switch provided at interior of the vehicle or a remote controller possessed by the passenger.

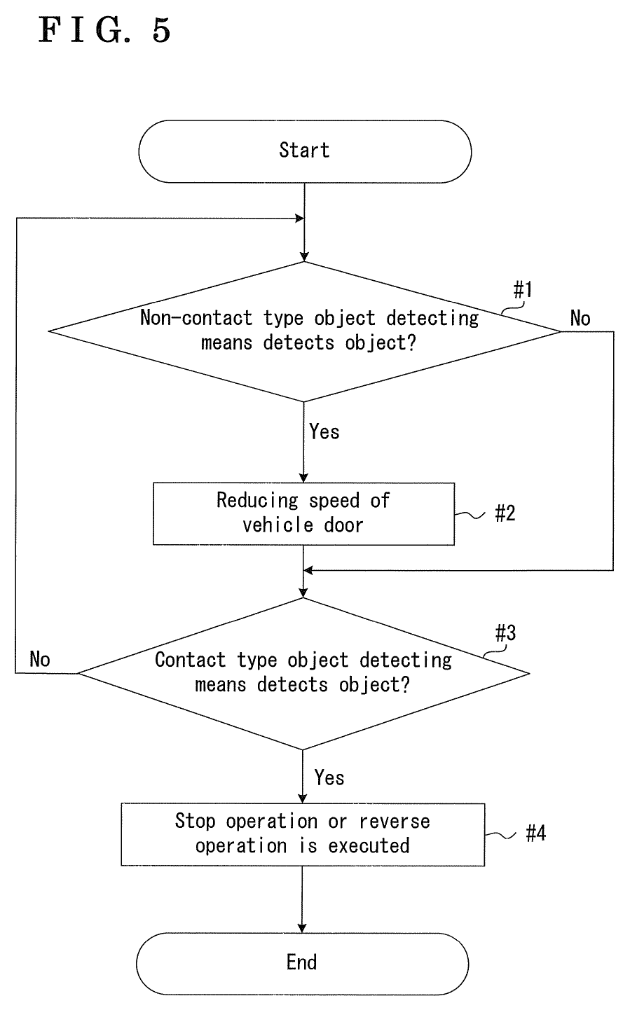

A control flow of the vehicle door opening/closing control apparatus according to the present invention while the door closing action is eclectically executed will be explained in accordance with FIG. 5. Once the door closing action is started, the non-contact type object detecting means 1 such as a microwave radar 1A scans the apertural area 5a of the vehicle door 5. When the non-contact type object detecting means 1 detects an object at the apertural area 5a of the vehicle door 5 (#1), the door closing action for the vehicle door 5 is changed to the speed reducing operation by means of the MPU 3a (#2). Further, when the contact type object detecting means 2 detects the contact of the object to the vehicle door 5 (#3), the MPU 3a executes the stop operation or the reverse operation for the door closing action of the vehicle door 5 (#4). Further, the contact of the object to the vehicle door 5 is detected by the contact type object detecting means 2 (#3), even when the object is not detected by the non-contact type object detecting means 1 (No in #1). Then, the stop operation or the reverse operation is executed for the door closing action of the vehicle door 5.

Further, a sensitivity level or a threshold of the contact type object detecting means 2 during each of the speed reducing operation and the normal operation may be set to different values. For example, during the speed reducing operation, because it may be considered that possibility that an object contacts the vehicle door 5 is relatively high, the sensitivity level of the contact type object detecting means 2 may be set to be higher, or the threshold of the contact type object detecting means 2 may be set to be lower. Apparently, the sensitivity level of the contact type object detecting means 2 may be set to be higher, and the threshold of the contact type object detecting means 2 may be set to be lower. Generally, when the sensitivity level and the threshold of the sensor are changed as mentioned above, a level of noise resistance may be reduced. However, according to the present invention, because the object is detected by means of both of a non-contact and a contact method, the sensitivity level and the threshold of the sensor may be changed only when a possibility that the object contacts the vehicle door 5 is relatively high. As a result, even when the noise resistance is reduced, the level of the affect on the detection result may be reduced.

The stop operation in the process #4 includes a control for stopping the motor 4A by means of the MPU 3a (control means 3) and a mechanical braking control for starting a mechanical braking apparatus. The reverse operation includes an operation executed until the vehicle door 5 is fully opened.

In the process #4, the MPU 3a (control means 3) may execute a following control. On the basis of the detection result from the contact type object detecting means 2, the MPU 3a executes the reverse operation for a predetermined time period to the motor 4A, and on the basis of the signal from the speed sensor 2A, the stop operation is executed after the predetermined time period passes, regardless of whether or not the vehicle door 5 is in a fully opened position. Even when the stopping control or the braking control is executed, a time lag occurs until the vehicle door 5 is completely stopped. Further, because the vehicle door is moving in a closing direction with an inertia force, during this period, a level of the contact (entrapment) may further be worse. It is better to return the vehicle door 5 to a position before the contact of the object to the vehicle door 5 happened than stopping the vehicle door 5 at a point where the contact or the entrapment of the object happens. On the other hand, when the contact of the object to the vehicle door 5 is detected, if the vehicle door 5 is returned to be in the fully opened position, an extra time will be required to execute the door closing action again, as a result, a level of convenience may be reduced. Thus, as mentioned above, it is better to stop the motor 4A after the reverse operation is executed for the motor 4A during a predetermined time in which the vehicle door 5 is returned to a position at least before the object contacts the vehicle door 5.

Thus, when the object approaching to the vehicle door is detected, a preventive measure for the entrapment (e.g., speed reducing operation) can be implemented at this point. Further, when the object approaching to the vehicle door is detected, it may be expected that the object will contact the vehicle door. Accordingly, even when the starting point of the contact at which the value of the signal indicating the contact is relatively low, the object can be detected on the basis of the signal by appropriately setting sensitivity of a determination threshold for the sensor.

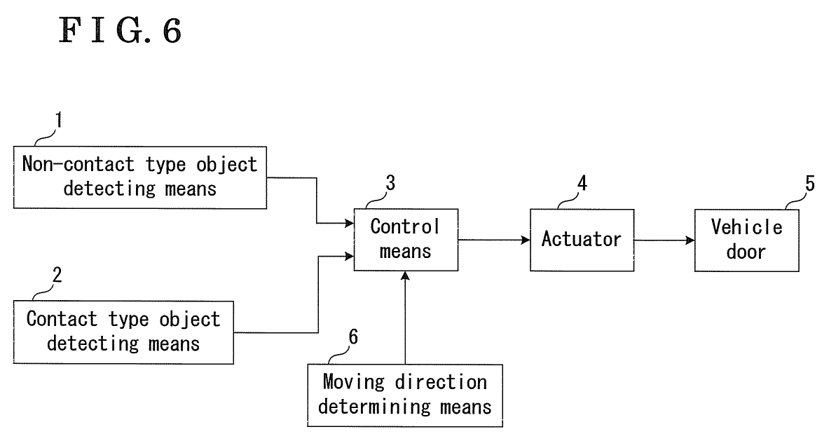

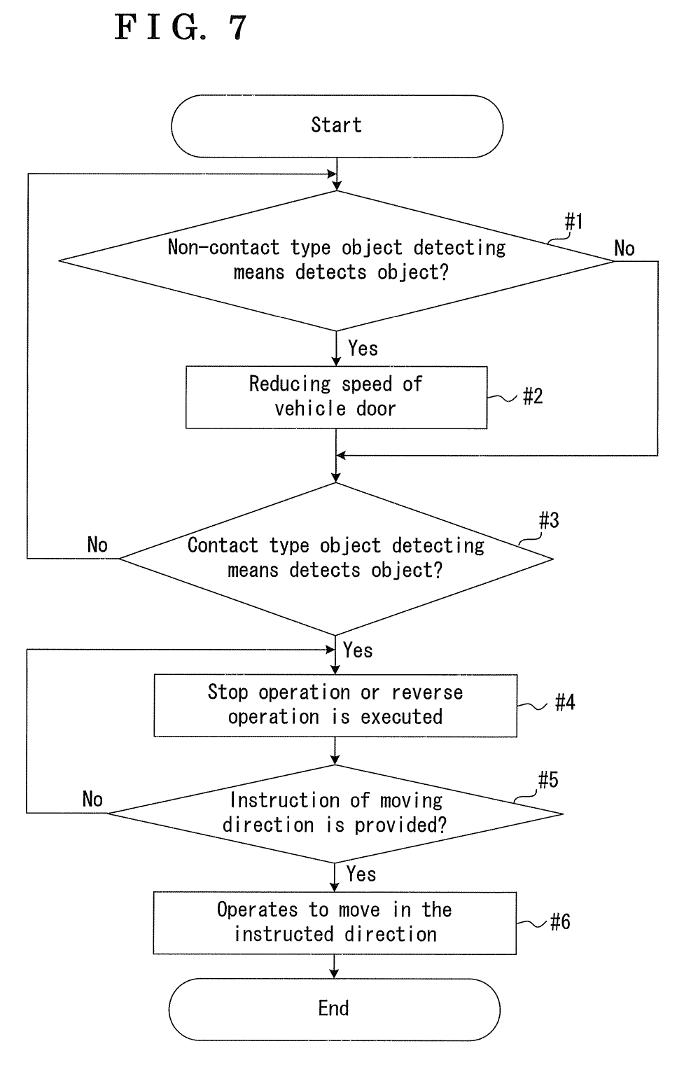

At this point, as illustrated in FIG. 6, by adding a moving direction determining means 6 to the configuration illustrated in FIG. 4, an operation after the stop operation or the reverse operation is controlled further appropriately. The moving direction determining means 6 determines the direction of the movement of the vehicle door 5, which is instructed by the passenger. For example, the MPU 3a in the configuration illustrated in FIG. 2 serves as the moving direction determining means 6. An example of a control executed by the vehicle door opening/closing control apparatus to which the moving direction determining means 6 is added will be explained in accordance with a flowchart illustrated in FIG. 7. Because operations #1 through #4 in the control illustrated in FIG. 7 are the same as the operations in the control illustrated in FIG. 5, explanations of these operations are omitted.

The moving direction determining means 6 determines an instruction for moving the vehicle door 5 by the passenger, on the basis of the detection result from an opening/closing instruction detecting means 7, and an instructed direction of the movement of the vehicle door 5 (#5). At this point, the opening/closing instruction detecting means 7 may be an operation switch provided at the interior of the vehicle or a remote controller possessed by the passenger, such as the door handle 7A and a switch 7B illustrated in FIG. 4. Further, when the passenger manually operates the vehicle door 5, the speed sensor 2A may detect the start of the rotation of the motor 4A. In this case, the speed sensor 2A corresponds to the contact type object detecting means 2 and the opening/closing instruction detecting means 7. On the basis of the detection result from opening/closing instruction detecting means 7 for determining an instruction provided by the passenger, the MPU 3a executes the door closing action or the door opening action for the motor 4A. Specifically, the motor 4A is actuated in a direction (a door opening action direction or a door closing action direction), which is instructed by the passenger (#6).

After the object contacts the vehicle door 5 and the electric power movement of the vehicle door 5 is stopped, the passenger may consider executing the door closing action again, or executing the door opening action. In this case, on the basis of the detection result from the moving direction determining means 6, the door opening action or the door closing action is executed for the motor 4A, a level of convenience of the vehicle door 5, which is electrically moved, can be increased.

In the examples illustrated in FIG. 5 and FIG. 7, once the non-contact type object detecting means 1 detects an existence of the object (#1), the door closing action is terminated, or the speed reducing operation has been executed until the object actually contacts the vehicle door 5 (#2). After the process #2 determines “No”, a process of a “normal operation” may be added to the routine. Specifically, when the existence of the object is detected, the speed reducing operation is executed, and when the existence of the object is eliminated, the speed of the door closing action may be returned to that in the normal operation.

### Other Embodiments

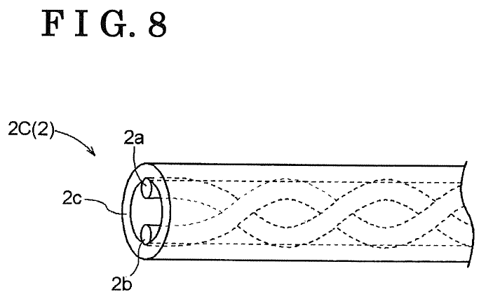

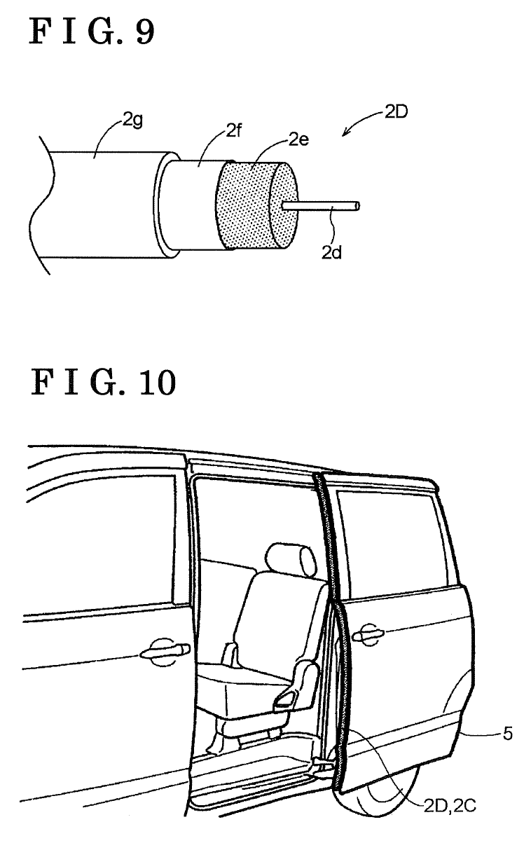

The non-contact type object detecting means 1 may include a laser radar, a supersonic type radar or a capacitance type non-contact sensor, instead of the microwave radar 1A. The contact type object detecting means 2 may include a pressure-sensitive sensor 2C illustrated in FIG. 8 or a piezoelectric sensor 2D illustrated in FIG. 9 (e.g., a cable-shaped sensor).

The pressure-sensitive sensor 2C illustrated in FIG. 8 includes at least two electrode wires 2a and 2b and an insulating body 2c formed in a long pipe shape so as to have a hollow therein. Each of the electrode wires 2a and 2b are provided within the hollow of the insulating body 2c in a manner where they spirally extend in a longitudinal direction of the insulating body 2c so as not to electrically contact each other. When a pressure is applied to the pressure-sensitive sensor 2C, the insulating body 2c is deformed in a manner where the hollow changes its shape, as a result, each of the two electrode wires 2a and 2b, which are provided within the hollow in the insulating body 2c, electrically contact each other. The pressure applied to the pressure-sensitive sensor 2C is detected by detecting the contact between the electrode wires 2a and 2b, depending on a change of a resistance value between the electrode wires 2a and 2b and a change of a electric value flowing each the electrode wire 2a and 2b.

The piezoelectric sensor 2D illustrated in FIG. 9 includes a piezoelectric body 2e, a first electrode 2d, a second electrode 2f and a coating 2g. The first electrode 2d is made of a conducting wire or a core to which an electric conductor is wound, the second electrode 2f is formed in a tube shape, and the piezoelectric body 2e is sandwiched between the first electrode 2d and the second electrode 2f. Further, the first and second electrodes 2d and 2f and the piezoelectric body 2e are coated by the coating 2g so as to form into a coaxial cable shape. In this configuration, when the piezoelectric body 2e is deformed due to a mechanical external force caused by acceleration, vibration or contact, an electric charge is generated thereat, and an electric signal is generated between the first and second electrodes 2d and 2f.

Because the pressure-sensitive sensor 2C and the piezoelectric sensor 2D are formed in a cable shape, an external force applied in any radial direction can be detected by the sensor, and further, these sensors are easily mounted to, for example, a vehicle door. Thus, these sensors can be appropriately mounted to an end portion of the vehicle door 5 as illustrated in FIG. 10.

The piezoelectric body 2e of the piezoelectric sensor 2D is a ferroelectric substance, which is able to indicate a pyroelectric effect together with a piezoelectric effect and store an electric charge of an electric capacitance.

For example, when an external force is applied to the piezoelectric sensor 2D by an object contacting thereto, the piezoelectric body 2e indicates a polarization phenomenon and generates an electric charge by means of the piezoelectric effect. Further, the generated electric charge is outputted as an output signal represented as a variation of a potential difference between the first electrode 2d and the second electrode 2f. At this point, the more the level of the external force applied to the piezoelectric body 2e, the more the electric charge amount generated due to the polarization of the piezoelectric body 2e increases. Thus, while an object contacts the vehicle door 5, the level of the output signal from the piezoelectric sensor 2C at a later stage of the contact is larger than the level of the output signal from the piezoelectric sensor 2C at an early stage of the contact. In the early stage, a relatively small external force is applied to the piezoelectric body 2e, and in the later stage, a relatively large external force is applied to the piezoelectric body 2e.

When the piezoelectric body 2e receives external thermal energy from a heat source approaching thereto, the piezoelectric body 2e indicates a polarization phenomenon and generates an electric charge by means of the pyroelectric effect. Further, the generated electric charge is outputted as an output signal represented as a variation of a potential difference between the first electrode 2d and the second electrode 2f. At this point, as the level of the thermal energy received by the piezoelectric body 2e becomes high, the electric charge amount generated due to the polarization of the piezoelectric body 2e increases. Accordingly, as an object is approaching to the piezoelectric sensor 2D provided at the vehicle door 5, the electric charge amount generated due to the polarization of the piezoelectric body 2e gradually changes, and when the object eventually contacts the piezoelectric sensor 2D, the electric charge amount significantly changes. Using the output signal generated by the pyroelectric effect at the piezoelectric body 2e (dielectric substance) and outputted by the piezoelectric sensor 2D, both the approach and the contact of the object relative to the piezoelectric sensor 2D are detected. In other words, in this case, the piezoelectric sensor 2D corresponds to the contact type object detecting means 2 of the present invention and also corresponds to the non-contact type object detecting means 1.

Further, when the object approaches the piezoelectric sensor 2D, the electric capacitance between the first and second electrodes 2d and 2f changes. This change is outputted as an output signal represented as a variation of a potential difference between the first electrode 2d and the second electrode 2f. Accordingly, as the object approaches the piezoelectric sensor 2D, the electric capacitance gradually changes, and when the object eventually contacts the piezoelectric sensor 2D, the electric charge amount is significantly changed. Using the output signal generated due to the change of the electric capacitance between the first and second electrodes 2d and 2f and outputted by the piezoelectric sensor 2D, both the approach and the contact of the object relative to the piezoelectric sensor 2D are detected. In other words, in this case, the piezoelectric sensor 2D corresponds to the contact type object detecting means 2 of the present invention and also corresponds to the non-contact type object detecting means 1.

An embodiment in which the piezoelectric sensor 2D illustrated in FIG. 9 is used as the non-contact type object detecting means 1 and the contact type object detecting means 2 will be explained.

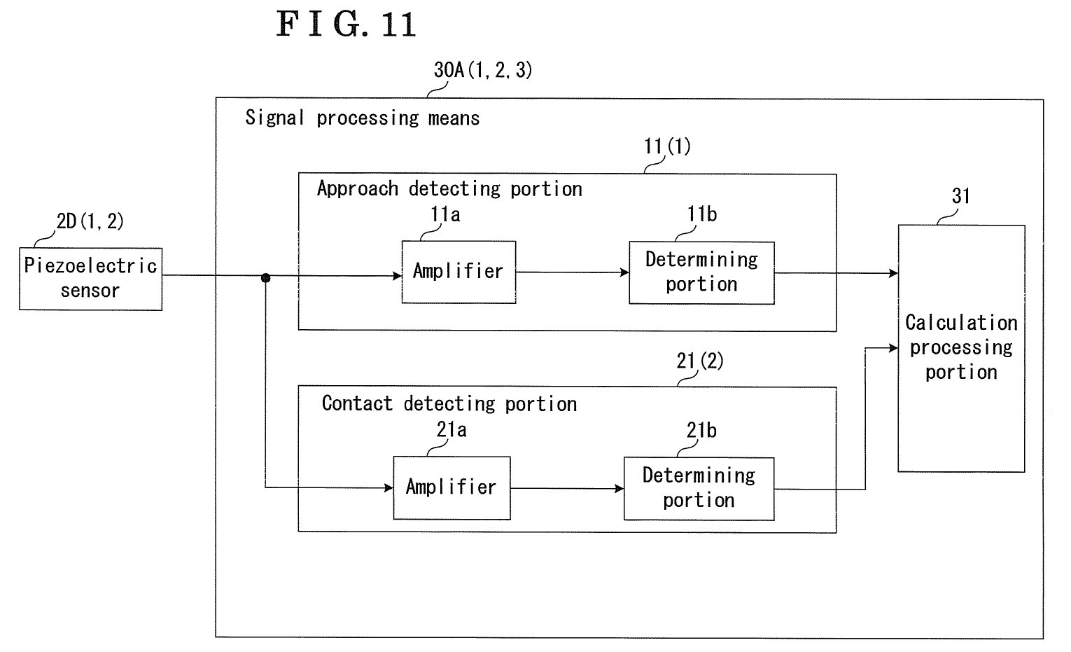

As illustrated in FIG. 11, the signal processing means 30A includes an approach detecting portion 11 for executing an approach detecting process and a contact detecting portion 21 for executing a contact detecting process. Specifically, the approach detecting portion 11 executes the approach detecting process for detecting that an object is approaching the piezoelectric sensor 2D on the basis of an output signal from the piezoelectric sensor 2D. The contact detecting portion 21 executes a contact detecting process for detecting that the object contacts the piezoelectric sensor 10 on the basis of the output signal from the piezoelectric sensor 2D. As illustrated in FIG. 11, the approach detecting portion 11 includes an amplifier 11a and a determining portion 11b, and the contact detecting portion 21 includes an amplifier 21a and a determining portion 21b. Each of the approach detecting portion 11 and the contact detecting portion 21 is comprised of a circuit respectively. The approach detecting portion 11 corresponds to the non-contact type object detecting means 1 of the present invention, and the contact detecting portion 21 corresponds to the contact type object detecting means 2 of the present invention. The approach detecting process and the contact detecting process are allowed to be simultaneously executed.

The signal processing means 30A further includes a calculation processing portion 31. The calculation processing portion 31 calculates a detection result of the object as a whole on the basis of the results from the approach detecting portion 11 and the contact detecting portion 21. On the basis of the calculation result, the control means 3 controls the actuator 4. The calculation processing portion 31 adjusts amplification rates at the amplifier 11a of the approach detecting portion 11 and the amplifier 21a of the contact detecting portion 21 and adjusts thresholds at the determining portions 11b and 21b. The calculation processing portion 31 serves as a part of the functions of the non-contact type object detecting means 1, the contact type object detecting means 2 and the control means 3. The calculation processing portion 31 is achieved by, for example, a MPU 3a (see FIG. 2).

A specific example of the object detection will be explained. While an object is not approaching or contacting the vehicle door 5, the output signal (including a signal after the amplification) from the piezoelectric sensor 2D is constant (not varying and defined as an output zero). Then, when, for example, a passenger approaches the piezoelectric sensor 4D provided at the vehicle door 5 in order to get into the vehicle, the level of the output signal increases.

The determining portion 11b of the approach detecting portion 11 determines that the object is approaching the piezoelectric sensor 2D when the level of the output signal becomes more than a first threshold. The determining portion 11b of the approach detecting portion 11 also determines that the object contacts the piezoelectric sensor 2D when the level of the output signal becomes more than a second threshold. For example, when a passenger considered as a heat source approaches the piezoelectric sensor 2d when he/she intends to get in the vehicle, the level of the output signal of the piezoelectric sensor 2D starts increasing so as to exceed the first threshold. Further, when the passenger contacts the piezoelectric sensor 2D, the level of the output signal of the piezoelectric sensor 2D further increases so as to exceed the second threshold. The determining portion 11b determines whether or not the level of the output signal exceeds the first threshold, and the determination result is outputted to the calculation processing portion 31. The calculation processing portion 31 (MPU 3a) transmits information indicating that the object is approaching the piezoelectric sensor 2D to the control means 3 (MPU 3a), and then the control means 3 (MPU 3a) executes an action for dealing with the potential entrapment. Specifically, the control means 3 (MPU 3a) controls the motor 4A to execute a speed reducing operation or the like in order to reduce the speed of the movement of the vehicle door 5, which is moving in one direction.

When the object contacts the vehicle door 5, because the level of the output signal from the piezoelectric sensor 2D becomes significantly high, the calculation processing portion 31 sets the amplification rate at the amplifier 21a of the contact detecting portion 21 so as to be smaller than the amplification rate at the amplifier 11a of the approach detecting portion 11. Further, the calculation processing portion 31 sets a threshold for the output signal used by the determining portion 21b of the contact detecting portion 21. The threshold at this point is set to be lower so as to correspond to a signal that is outputted from the piezoelectric sensor 2D at a starting point of the contact of the object to the piezoelectric sensor 2D. If the approach detecting portion 11 has detected that the object is approaching the piezoelectric sensor 2D, a possibility of a contact of the object to the piezoelectric sensor 2D may be anticipated. Thus, in this configuration, even when the threshold is set to be lower, a detection error may be reduced. When the level of the output signal becomes equal to or more than the threshold, the determining portion 21b determines that the object contacts the piezoelectric sensor 2D. Once the MPU 3a (the calculation processing portion 31 and the control means 3) receives information indicating that the object contacts the piezoelectric sensor 2D from the determining portion 21b, the MPU 3a controls the control means the vehicle door 5 to execute the stop operation or the reverse operation, in order to prevent the object from being entrapped at the vehicle door 5.

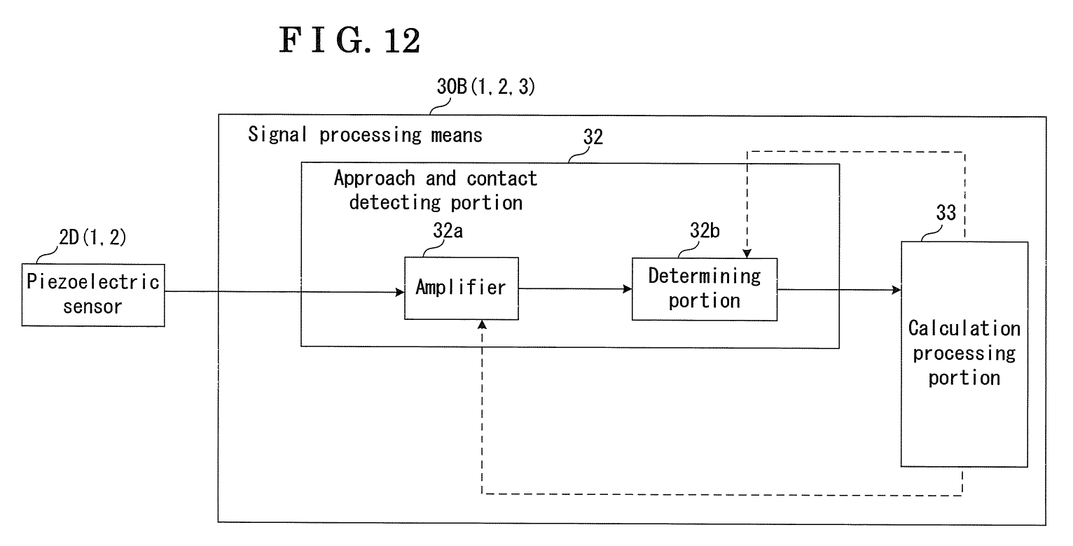

The configuration of the signal processing means 30A may not be limited to the above-described configuration and may be modified as follows. For example, as illustrated in FIG. 12, the signal processing means 30B may include an approach and contact detecting portion 32 by which the approach detecting process and the contact detecting process are selectively executed as needed. As illustrated in FIG. 12, the signal processing means 30B includes: the approach and contact detecting portion 32 having an amplifier 32a and a determining portion 32b; and a calculation processing portion 33. The amplifier 32a amplifies the output signal from the piezoelectric sensor 2D. The determining portion 32b determines a state of the contact or the approach selectively on the basis of the amplified signal and the threshold. The calculation processing portion 33 receives the signal from the approach and contact detecting portion 32 and command the approach and contact detecting portion 32 to change a set value (e.g., the amplification rate and the threshold). Further, the calculation processing portion 33 controls the approach and contact detecting portion 32 to be in an approach detecting process mode or in a contact detecting process mode. For example, the calculation processing portion 33 can control the approach and contact detecting portion 32 to be in the approach detecting process mode or in the contact detecting process mode, by changing the amplification rate or the threshold in a single circuit. Because these modes are the same as that of the signal processing means 30A, a detailed expression of them are omitted.

As mentioned above, according to the present invention, a vehicle door opening/closing control apparatus by which an impact applied to the object when it is entrapped by the vehicle door is reduced, and the object is released form the entrapment as soon as possible, while convenience of a vehicle door moved by an electric power is maintained, can be provided.

According to the embodiment of the present invention, the speed of the door closing action of the vehicle door is changed on the basis of the detection of the existence of the object at the apertural area of the vehicle door by the non-contact type object detecting means. For example, when the non-contact type object detecting means detects the existence of the object, the speed of the door closing action is reduced, and when the existence of the object is eliminated, the speed of the door closing action is increased so as to be returned to the previous speed. The speed may not be increased after the existence of the object is detected until the door closing action is completed. When the non-contact type object detecting means detects the object, the level of possibility that the entrapment happens is high. At this point, because the speed of the door closing action of the vehicle door is reduced, when the object contacts the vehicle door, an impact applied to the object by the vehicle door can be reduced. Further, when the approach of the object is detected, the contact of the object is anticipated. Accordingly, the sensitivity level or the threshold for the detecting means can be adjusted at the early stage of the contact at which the value of the signal indicating the contact is relatively low so that the contact can be detected on the basis of the signal. Because the door closing action is executed at a normal speed when the non-contact type object detecting means does not detect the object, convenience of the vehicle door, which is electrically moved, is maintained. Further, because the actuator is stopped or reversed on the basis of the detection result from the contact type object detecting means for detecting the contact of the object to the vehicle door, the object can be released from the entrapment at an early stage.

According to the vehicle door opening/closing control apparatus of the present invention, even when the non-contact type object detecting means detects the existence of the object at the apertural area of the vehicle door, the control means does not control the actuator to execute the stop operation or the reverse operation when the contact type object detecting means does not detect the contact of the object to the vehicle door. Thus, comparing to a case where only the non-contact type object detecting means is used for detecting that the object is entrapped by the vehicle door, the vehicle door opening/closing control apparatus of the present invention can reduce useless stop operation or reverse operation based upon inaccurate detecting results for the vehicle door, more effectively. Further, as mentioned above, because the level of the possibility that the entrapment happens is increased when the non-contact type object detecting means detects the existence of the object, the control means changes the speed of the door closing action for the vehicle door. However, when the contact type object detecting means does not detect the contact of the object to the vehicle door, the door closing action is executed without executing the stop operation or the reverse operation. If the entrapment is detected only by use of the non-contact type object detecting means, even when the actual entrapment does not happen, the stop operation or the reverse operation is executed for the vehicle door based upon the detection result of the existence of the object at the apertural area. According to the embodiment of the present invention, when the contact of the object to the vehicle door is not detected, the door closing action is controlled so as to reduce its speed. Thus, convenience of the vehicle door, which is moved by the electric power, is maintained.

According to the embodiment of the present invention, the control means controls the actuator to execute the reverse operation for a predetermined time period and then to execute the stop operation, on the basis of the detection result from the contact type object detecting means. Accordingly, the vehicle door is stopped at a position being apart from the object with a distance in which the vehicle door is moved by the reverse operation executed for the predetermined time period. When the reverse operation is executed for the vehicle door, and the vehicle door becomes in the fully opened state after the contact of the object to the vehicle is detected, a repeated door closing action for the vehicle door needs to be executed for a long time period. As a result, the level of the convenience of the vehicle door, which is moved by the electric power, is lowered. According to the embodiment of the present invention, because the actuator is stopped after the predetermined time period passes, regardless of whether or not the position of the vehicle door reaches a fully opened position, the level of the convenience of the vehicle door can be maintained.

After the electric power movement of the vehicle door is stopped when the object contacts the vehicle door, the passenger may intends to execute the door closing action again, or intends to execute the door opening action. Because the electric power movement is stopped, the passenger can manually instruct the direction of the vehicle door movement to the vehicle door by means of the operation switch or the remote controller. Thus, according to the embodiment of the present invention, the moving direction determining means is provided in order to determine the direction of the movement of the vehicle door on the basis of the instruction from the passenger. On the basis of the determination result from the moving direction determining means, the door opening action or the door closing action is executed for the actuator. As a result, the level of the convenience of the vehicle door, which is moved by the electric power, can be increased.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A vehicle door opening/closing control apparatus comprising:
an actuator for executing a door opening action and a door closing action for a vehicle door in order to open and close an apertural area formed at a vehicle body by applying a driving force to the vehicle door;
non-contact type object detecting means for detecting an existence of an object at the apertural area of the vehicle body while the door closing action is executed for the vehicle door;
contact type object detecting means for detecting a contact of the object to the vehicle door, the contact interrupting the door closing action; and
control means for controlling the actuator to execute the door opening action and the door closing action for the vehicle door at a predetermined speed, for controlling the actuator to execute the door closing action for the vehicle door with changing a speed of the door closing action for the vehicle on the basis of a detection result from the non-contact type object detecting means during the actuator is controlled to execute the door closing action for the vehicle door, and for controlling the actuator to stop the door closing action after one of a stop operation and a reverse operation for the actuator is executed on the basis of a detection result from the contact type object detecting means during the actuator is controlled to execute the door closing action for the vehicle door.

2. The vehicle door opening/closing control apparatus according to claim 1, wherein
the control means controls the actuator in a manner where the speed of the door closing action for the vehicle door is slower than the predetermined speed when the control means determines that the object exists at the apertural area on the basis of the detection result from the non-contact type object detecting means

3. The vehicle door opening/closing control apparatus according to claim 2, wherein
the control means control the actuator in a manner where the speed of the door closing action for the vehicle door is equal to the predetermined speed when the control means determines that the existence of the object at the apertural area is eliminated on the basis of the detection result from the non-contact type object detecting means.

4. The vehicle door opening/closing control apparatus according to claim 2, wherein
the control means controls the actuator in a manner where the speed of the door closing action for the vehicle door is slower than the predetermined speed until the contact of the object to the vehicle door is detected on the basis of the detection result from the contact type object detecting means.

5. The vehicle door opening/closing control apparatus according to claim 1 further including
a position detecting means for detecting a position of the vehicle door, wherein, while the control means controls the actuator to execute the reverse operation for the vehicle door for a predetermined time period on the basis of the detection result from the contact type object detecting means, wherein
the control means controls the actuator to stop the reverse operation for the vehicle door after the predetermined time period passes regardless of whether or not the position of the vehicle door detected on the basis of a signal from the position detecting means reaches a fully opened position.

6. The vehicle door opening/closing control apparatus according to claim 1 further including
moving direction determining means for detecting a moving direction of the vehicle door instructed by a passenger, wherein
the control means controls the actuator so as to execute one of the door opening action and the door closing action for the vehicle door on the basis of the determination result from the moving direction determining mean after the door closing action for the vehicle door is stopped on the basis of the detection result from the contact type object detecting means.

7. The vehicle door opening/closing control apparatus according to claim 1, wherein
the contact type object detecting means includes a cable-shaped sensor attached to an end portion of the vehicle door.

8. The vehicle door opening/closing control apparatus according to claim 7, wherein
the cable-shaped sensor is a piezoelectric sensor and functions as a non-contact type object detecting means.
